(19) United States
(12) Patent Application Publication
(10) Pub. No.: US 2013/0097361 A1
(43) Pub. Date: Apr. 18, 2013

(54) MEMORY DEVICE

(71) Applicant: MENG-LIANG YANG, Shenzhen City (CN)

(72) Inventor: MENG-LIANG YANG, Shenzhen City (CN)

(73) Assignees: HON HAI PRECISION INDUSTRY CO., LTD., Tu-Cheng (TW); HONG FU JIN PRECISION INDUSTRY (ShenZhen) CO LTD., Shenzhen City (CN)

(21) Appl. No.: 13/286,167

(22) Filed: Oct. 31, 2011

(30) Foreign Application Priority Data
Oct. 12, 2011 (CN) 201110308109.8

(51) Int. Cl. G06F 12/00

(52) U.S. Cl. 711/103; 711/E12.008

(57) ABSTRACT

A memory device includes a control part and a storage part. The control part includes a first interface, a second interface, and a storage controller. The first interface is connected to an electronic device through a first bus. The second interface is connected to the storage controller through a second bus. The storage part includes a third interface and a storage unit. The storage unit is connected to the third interface through a third bus. The control part and the storage part are connected through a connection of the second interface and the third interface.

### BACKGROUND

1. Technical Field

The present disclosure relates to an memory device, especially relates to a memory device which can be separated to two parts.

2. Description of Related Art

Referring to FIG. 1, a conventional Solid State Disk (SSD) 10 includes a flash controller 101 and flash chips 102. The flash controller 101 and the flash chips 102 are connected through a flash bus 103. Due to the flash controller 101 and the flash chips 102 cannot be separated, damage to either the flash controller 101 or the flash chips 102 will render the SSD 10 unusable, thus results in unnecessary waste.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of a Solid State Disk in related art.

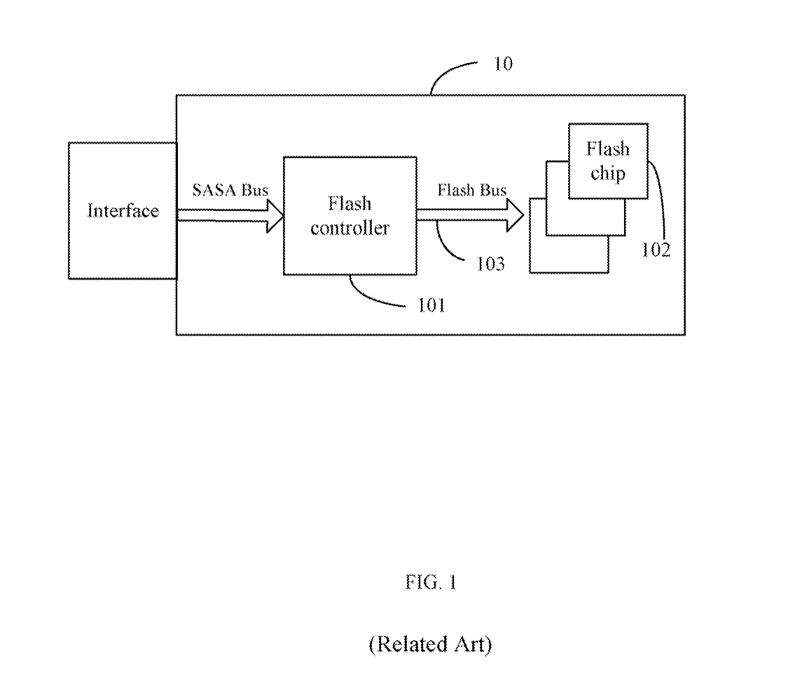

FIG. 2 is a block diagram of a memory device in accordance with an exemplary embodiment.

### DETAILED DESCRIPTION

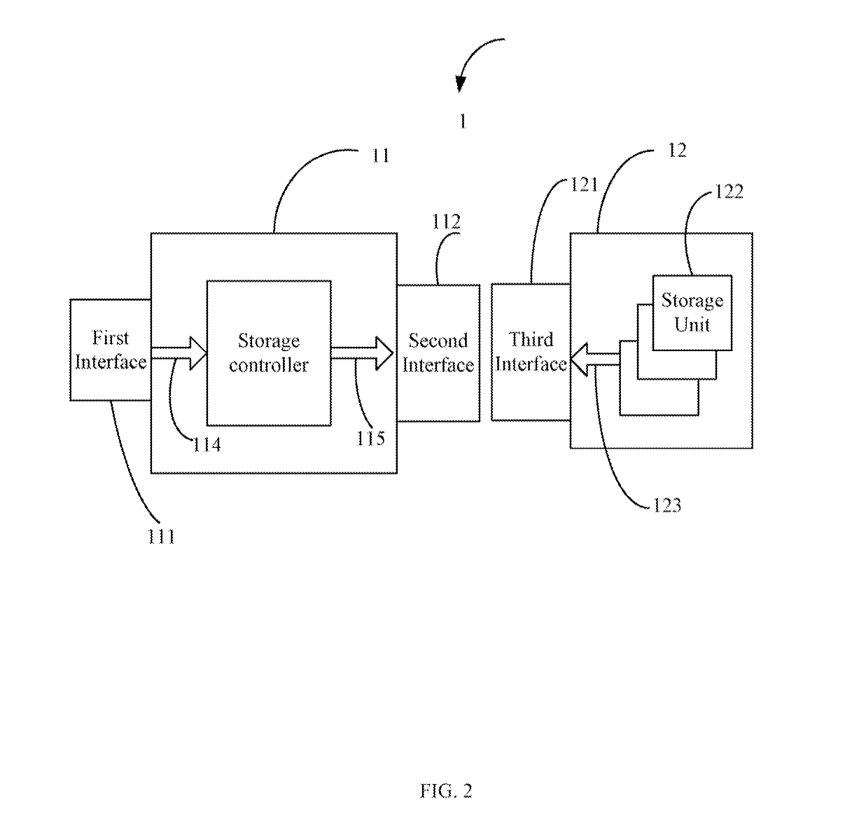

Referring to FIG. 2, a memory device 1 includes a control part 11 and a storage part 12. The control part 11 includes a first interface 111, a second interface 112, and a storage controller 113. The memory device 1 is connected to an electronic device (not shown) through the first interface 111. The first interface 111 is connected to the storage controller 113 through a first bus 114. The second interface 112 is connected to the storage controller 113 through a second bus 115.

The storage part 12 includes a third interface 121 and a storage unit 122. The storage unit 122 is connected to the third interface 121 through a third bus 121.

The control part 11 and the storage part 12 are connected through a connection of the second interface 112 and the third interface 121. The storage controller 113 controls the storage unit 122 of the storage part 12 to read and write data. Thus, when the storage part 12 is broken, the broken storage part 12 can be replaced with a new one, and the control part 11 can continue to be used , or when the control part 11 is broken, the broken control part 11 can be replaced with a new one, and the storage part 12 can continue to be used.

In the present embodiment, the storage device 1 is a SSD. The first interface 111 is a Serial Advanced Technology Attachment (SASA) interface. The storage unit 122 is a flash memory. The first bus 114 is a SASA bus. The second bus 115 and the third bus 123 are flash bus.

In the present embodiment, the second interface 112 and the third interface 121 includes data signal pins, address signal pins, control signals pins, and a ground signal pin.

Although, the present disclosure has been specifically described on the basis of preferred embodiments, the disclosure is not to be construed as being limited thereto. Various changes or modifications may be made to the embodiment without departing from the scope and spirit of the disclosure.

What is claimed is:

1. A memory device comprising:
a control part comprising a first interface, a second interface and a storage controller, wherein the first interface is connected to an electronic device through a first bus, and the second interface is connected to the storage controller through a second bus; and
a storage part comprising a third interface and a storage unit, wherein the storage unit is connected to the third interface through a third bus;
wherein the control part and the storage part are connected through a connection of the second interface and the third interface.

2. The memory device as described in claim 1, wherein the memory device is a Solid State Disk.

3. The memory device as described in claim 1, wherein the storage unit is a flash memory.

4. The memory device as described in claim 1, wherein the second bus and the third bus are flash bus.
